(19) United States
(12) Patent Application Publication
(10) Pub. No.: US 2007/0211623 A1
(43) Pub. Date: Sep. 13, 2007

(54) FAILURE RECOVERY METHOD, NETWORK DEVICE, AND PROGRAM

(75) Inventor: Itaru Nishioka, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation, Tokyo (JP)

(21) Appl. No.: 11/574,380

(22) PCT Filed: Aug. 29, 2005
(86) PCT No.: PCT/JP05/15620

§ 371 Date: Feb. 27, 2007

(30) Foreign Application Priority Data
Aug. 30, 2004 (JP) 2004-251872

(51) Int. Cl. H04L 12/56

(52) U.S. Cl. 370/218

(57) ABSTRACT

In a network composed of a plurality of network devices (4) equipped with a group of control modules (21) having a routing protocol section (6) for exchanging link information and a signaling protocol section (7) for determining a path, when a failure occurs in a link constituting the current path, a first network device (4) switches the one or more failed current paths to auxiliary paths previously computed and starts to send a routing packet relevant to the advertisement of the one or more failed links by the routing protocol section (6) after when the signaling protocol section (7) sends a signaling message for switching the all or part of the failed one or more current paths to the auxiliary paths.

### APPLICABLE FIELD IN THE INDUSTRY

The present invention relates to a failure recovery method and a network device, and more particularly to a failure recovery method in a network that is configured of network devices equipped with a group of control modules having a routing protocol for exchanging link information and a signaling protocol for determining a path.

### BACKGROUND ART

Employing a GMPLS (Generalized Multi-Protocol Label Switching) control technology enables a failure recovery in a mesh topology to be realized. The failure recovery technique in the mesh topology is divided into a pre-planned recovery technique of previously computing an auxiliary path for a current path, and a dynamic recovery technique of computing an auxiliary path after detecting the failure. Each of them is divided into a link failure recovery technique of making a switchover to the auxiliary path at both ends of the link in which the failure has occurred in a link unit, and a path failure recovery technique of switching the entirety of the path ranging from a start-point node to an end-point node in a path unit. In addition hereto, the pre-planned recovery/path failure recovery technique has three types of 1+1, 1:1, and Shared. The three types of the pre-planned recovery/path failure recovery technique are described as follows.

(1) 1+1

Both of the current path and the auxiliary path are determined previously to make a switchover to the auxiliary path only with the end-point node of the path in a case where the failure occurs in the current path.

(2) 1:1

The auxiliary path is computed and the bandwidth is reserved previously, but the switch is not set, and in a case where the failure occurs in the current path, the signaling processing is executed to determine the auxiliary path.

(3) Shared

This type is identical to the type of 1:1 except that the auxiliary path companions have a bandwidth in common.

These are described in Non-patent document 1.

Conventionally, in the failure recovery employing the GMPLS control technology, when a GMPLS controller of a node device receives a failure notification after occurrence of the failure, the failure recovery operations by the routing protocol and the signaling protocol are simultaneously started. The routing protocol transmits a packet in order to notify a change in a state of the failed link to the other node, and the signaling protocol transmits a packet for switching the failed path to the auxiliary path. These packets are simultaneously transmitted to a control channel of a control plane. In addition hereto, the routing protocol transmits a large amount of the packets at a time, which compete with the packet by the signaling protocol, thereby causing congestion to occur. For this, it takes much time to process the packet by the signaling protocol, and hence, it takes much time to recover the failure.

The conventional network was of small scale; however recently the network has been enlarged with an increase in traffic. This causes the number of the paths as well that are included in the link to be augmented. Consequently, when the link failure occurs, the number of the path for which the failure recovery has to be made is increased, and hence, the number of the packets by the signaling protocol and the routing protocol that are transmitted at the time of the failure recovery is also increased. An increase in the number of the packet causes an influence of the congestion to come out conspicuously. Accompanied by this, the failure recovery time is lengthened, so it is an urgent need to reduce the failure recovery time.

One of the measures for solving such a problem is described in Non-patent document 2. The Non-patent document 2 mentions that the control message storm is generated and the congestion occurs because of the signaling for the failure recovery and the publication of the failed link by the routing that are executed path by path at the time of the failure, and shows a result of having experimentally evaluated an influence of the control traffic (a signaling amount associated with information of the path and a publication amount of the routing associated with link information) and the bandwidth of the control channel upon a scalability of a GMPLS control plane, and reaches the conclusion that reducing the failure recovery time necessitates the control channel having a sufficiently large bandwidth.

On the other hand, several technologies are known of avoiding the congestion in the network. For example, in Patent document 1, a communication processor of a data receiving side performs priority setting of the packet in accordance with information such as the transmission source IP address, transmission destination IP address, transmission source port number, transmission destination port number and protocol of the packet, and performs scheduling processing thereof, thereby to avoid the congestion. And the cancellation processing is performed for the packet having a low set priority. The packet accumulated in the queue is processed on the basis of the scheduling information. Further, in Patent document 2, a period when a packet transmission processing is congested is distinguished from a period when it is not congested, and data flow to which the transmission packet belongs is identified to preferentially transmit the packet responding to the communication quality of the data flow during a period when a packet transmission processing is congested, and the packet is transmitted in the order of requesting the transmission without identifying the data flow of the transmission packet during a period when it not congested. The period when the packet transmission processing is congested is determined based upon whether or not the number of the packets waiting for transmission that is in a transmission-wait state exceeds a threshold.

[Patent document 1] JP-P2001-332440A (page 3 to 4)

[Patent document 2] JP-P1997-126701A (page 3)

[Non-patent document 1] J. P. Lang and two others, “RSVP-TE Extensions in supporting of End-to-End GMPLS-based Recovery”, March, 2004

[Non-patent document 2] Itaru NISHIOKA and two others, “Study on Scalability of GMPLS Controlled Optical Networks for Channel Bandwidth and Control Traffic”, The Institute of Electronics, Information and Communication Engineers, Proceedings of the 2003 IEICE Society Conference, B-7-66, P. 247.

### DISCLOSURE OF THE INVENTION

### Problems to be Solved by the Invention

However, designing a bandwidth of the control channel to the situation at the time of the failure leads to an over-specification in a situation where the network operates normally, which is a waste of the resource. For this, it is desired to develop a new technique that enables the failure recovery time to be reduced without enlarging the bandwidth of the control channel.

Further, it is also thinkable to apply the prior art of avoiding the congestion at the time of the failure recovery; however the following becomes a subject of discussion.

The technique of sequentially performing a cancellation processing of the packet that has no matching data entry in the rule information management table or performing a cancellation processing of the packet, of which the time-out time has expired that is set in the scheduling rule information management table, in the ascending order of the priority degree, which is described in the patent document 1, gives rise to the problem that the packet results in being cancelled. Consequently, employing the technique mentioned above at the moment of the failure recovery causes the signaling packet to be canceled, brings about the wait state for re-transmission of the signaling packet, and incurs an anxiety over a delay in the failure recovery. Further, the technique of deciding the output order of the packet in accordance with the scheduling information described in the patent document 1 gives rise to the problem that it takes much time to process the signaling packet necessary for switching the failed path. The reason is that the situation in which the output processing of the packet accumulated in the queue, which has a high priority degree, is not temporally performed is generated because the output process of the packet accumulated in several prepared queues is performed in accordance with the arbitrarily decided scheduling.

Further, employing the technique of performing the scheduling processing of the packet only during a period when a packet transmission processing is congested, which is described in the patent document 2, gives rise to the problem that the scheduling processing is not performed for packet that is in a transmission-wait state. The reason is that it is determined that the congestion state has been reached at the time point that the number of the packet that is in a transmission-wait state has exceeded the threshold, whereby the scheduling processing is not performed for the packet prior to the time point that it has exceeded the threshold. Taking a priority control of the packet after determining that the congestion state has been reached gives rise to a competition between the signaling packet and the routing packet, which exerts an influence upon the failure recovery, because the signaling protocol and the routing protocol transmit a large amount of the packets for the purpose of the failure recovery at the time point of having received the failure information.

The present invention has been proposed in consideration of such circumstances, and an object thereof is to provide a novel failure recovery method and a novel network device that enable the failure recovery time to be reduced.

Another object of the present invention is to provide a failure recovery method and a network device that enable the pre-planned failure recovery to be carried out surely and fast.

### MEANS TO SOLVE THE PROBLEM

A failure recovery method of claim 1, in a network that is configured of a plurality of network devices comprising a group of control modules having a routing protocol section for exchanging link information and a signaling protocol section for determining a path, characterized in that when a failure occurs in a link constituting a current path, a first network device for performing a process of switching said one or more failed current paths to auxiliary paths previously computed start to transmit a routing packet relevant to a publication of the failed link by said routing protocol section after the time point that said signaling protocol section has finished transmission of a signaling message for switching all or one part of said failed one or more current paths to the auxiliary paths.

A failure recovery method of claim 2, in the failure recovery method according to claim 1, is characterized in that said first network device starts a publication of the failed link by said routing protocol section with it as a turning point that a switchover to the auxiliary paths has been finished by said signaling protocol section. The failure recovery method surely suppresses occurrence of a competition and a congestion and does not delay the publication of the failed link, by performing a process of switching said one or more failed current paths to auxiliary paths previously computed start to transmit a routing packet relevant to a publication of the failed link by said routing protocol section after the time point that said signaling protocol section has finished transmission of a signaling message for switching all or one part of said failed one or more current paths to the auxiliary paths.

A failure recovery method of claim 3, in the failure recovery method according to claim 2, is characterized in that said first network device determines that a switchover to the auxiliary paths has been finished when it has confirmed one round trip of the signaling message for switching said failed current path by the said signaling protocol section along a failure recovery path.

A failure recovery method of claim 4, in the failure recovery method according to claim 2 or claim 3, is characterized in that a second network device other than said first network device for switching said failed current path to the auxiliary paths previously computed starts to transmit a routing packet relevant to the publication of the failed link by said routing protocol section with it as a turning point that a switchover of all or one part of said failed one or more current paths to the auxiliary paths has been finished, said second network device being a network device having detected the failure that has occurred in the link constituting the current path.

A failure recovery method of claim 5, in the failure recovery method according to claim 4, is characterized in that when said second network device has received the routing packet relevant to the publication of the failed link from said first network device, it determines that a switchover of all or one part of said failed one or more current paths to the auxiliary paths has been finished.

A failure recovery method of claim 6, in a network that is configured of a plurality of network devices comprising a group of control modules having a routing protocol section for exchanging link information and a signaling protocol section for determining a path, is characterized in that a second control channel packaged with in-band signaling channel over a communication path is provided between the neighboring network devices, besides a first control channel packaged with out-of-band signaling over a communication path, and when a failure occurs in a link constituting a current path determined by said signaling protocol section, each of a packet for switching said one or more failed current paths to auxiliary paths by said signaling protocol section, and a routing packet relevant to a publication of the failed link by said routing protocol section is transmitted/received between the network devices through a different control channel, said different control channel being one of said first control channel and said second control channel.

As for the failure recovery method of claim 6, each of a packet for switching said one or more failed current paths to an auxiliary path by said signaling protocol section, and a routing packet relevant to a publication of the failed link by said routing protocol section is transmitted/received between the network devices through a different control channel. Thus, the failure recovery method suppresses occurrence of a competition between the packet of the signaling message and the routing packet, and avoids occurrence of the congestion, thereby allowing the pre-planned failure recovery to be carried out surely and fast.

A network device of claim 7 including a monitor section for detecting a failure, a failure information notifier for notifying the failure detected by the monitor section, a scheduling controller for carrying out a control of scheduling such as a change of a scheduling algorithm, and a group of control modules each of which become an object of scheduling, characterized in changing the scheduling algorithm that is applied for said group of control modules with the failure as a turning point.

A network device of claim 8 comprising a group of control modules having a routing protocol section for exchanging link information and a signaling protocol section for determining a path, characterized in that said network device, which comprises a path setting manager for, when a failure occurs in a link constituting a current path, detecting that a switchover of all or one part of said one or more failed current paths to auxiliary paths by the signaling protocol has been finished, does not transmits a routing packet relevant to a publication of the failed link by said routing protocol section until the path setting manager carries out said detection.

A network device of claim 9 comprising a group of control modules having a routing protocol section for exchanging link information and a signaling protocol section for determining a path, characterized in comprising: a failure information notifier for simultaneously notifying a failure of a current path to said signaling protocol section and said routing protocol section; a first queue into which a signaling packet of said signaling protocol section and a Hello packet of said routing protocol section are filed at the time of the failure of the current path; a second queue into which packets other than the Hello packet of said routing protocol section are filed at the time of the failure of the current path; a path setting manager for, at the time of the failure of the current path, monitoring whether a switchover of all failed paths to auxiliary paths has been finished; and a scheduling controller for, at the time of the failure of the current path, taking a transmission control of the packets filed into said first queue until a switchover of all failed paths to auxiliary paths is finished, and afterward, taking a transmission control of the packets filed into said second queue.

A network device of claim 10 comprising a group of control modules having a routing protocol section for exchanging link information and a signaling protocol section for determining a path, characterized in comprising: a failure information notifier for notifying a failure of a current path to said signaling protocol section; a queue into which a signaling packet of said signaling protocol section and a routing packet of said routing protocol section are filed; a path setting manager for, at the time of the failure of the current path, monitoring whether a switchover of all failed paths to auxiliary paths has been finished, and if a switchover of all failed paths to auxiliary paths has been finished, allowing said failure of said current path notified to said signaling protocol section to be notified to said routing protocol section as well; and a scheduling controller for taking a transmission control of the packets filed into said queue.

A network device of claim 11 comprising a group of control modules having a routing protocol section for exchanging link information and a signaling protocol section for determining a path, characterized in comprising: a failure information notifier for notifying a failure of a current path to said signaling protocol section and said routing protocol section; a transmitter/receiver for, at the time of the failure of the current path, transmitting/receiving a Hello packet by said routing protocol section and a packet by said signaling protocol section to/from the other network device through a first control channel packaged with in-band signaling, and transmitting/receiving the packets other than the Hello packet by said routing protocol section to/from the other network device through a second control channel packaged with out-of-band signaling; and a separator for transmitting the packet delivered from said transmitter/receiver to the neighboring network device by using said first control channel, and sending out the packet received through said first control channel from the neighboring network device to said transmitter/receiver.

### ADVANTAGEOUS OPERATION

The dynamic recovery technique, being one of the failure recovery techniques, poses a problem that a delay in the publication of the failed link by the routing protocol brings about the possibility that the auxiliary path using the failed link is computed because the auxiliary path is computed after detecting the failure, whereas the pre-planned recovery technique, which does not necessitate computing the auxiliary path after detecting the failure, does not pose a problem even though the publication of the failed link by the routing protocol is delayed. In the failure recovery method relevant to claim 1, which has been accomplished by paying attention to this point, the signaling message is transmitted at first, and thereafter, the transmission of the routing packet is started, which suppresses occurrence of a competition between the packet of the signaling message and the routing packet, and avoids occurrence of the congestion, thereby allowing the pre-planned failure recovery to be carried out surely and fast.

### EFFECTS OF THE INVENTION

The pre-planned failure recovery can be carried out surely and fast. The reason is that in the failure recovery method relevant to claim 1, occurrence of a competition between the packet of the signaling message and the routing packet is suppressed, and occurrence of the congestion is avoided because the signaling message is transmitted at first, and thereafter, the transmission of the routing packet is started. Further, the reason is that in the failure recovery method relevant to claim 6, a competition between the both packets is suppressed and occurrence of the congestion is avoided because each of the packet by the signaling protocol section, and the packet by the routing protocol section is transmitted/received between the network devices through a different control channel.

The bandwidth of the control channel over the control plane can be designed at a smaller size. The reason is that a competition between the signaling packet and the routing packet within the control channel of the control plane can be suppressed at the time of occurrence of the failure.

### BRIEF DESCRIPTION OF THE DRAWINGS

FIG. 1 is an explanatory view of a failure recovery operation by the signaling protocol in a first recovery method of the present invention.

FIG. 2 is an explanatory view of the operation by the routing protocol in the first recovery method of the present invention.

FIG. 3 is a view illustrating the failure recovery operation in accordance with the first recovery method of the present invention.

FIG. 4 is a block diagram of one embodiment of the network control device that is used in the first recovery method of the present invention.

FIG. 5 is a flowchart illustrating an operation of one embodiment of the network control device that is used in the first recovery method of the present invention.

FIG. 6 is a block diagram of another embodiment of the network control device that is used in the first recovery method of the present invention.

FIG. 7 is a flowchart illustrating an operation of another embodiment of the network control device that is used in the first recovery method of the present invention.

FIG. 8 is a view illustrating the failure recovery operation in accordance with a second recovery method of the present invention.

FIG. 9 is a block diagram of one embodiment of the network control device that is used in the second recovery method of the present invention.

### DESCRIPTION OF NUMERALS

1 link
2 signaling packet
3 routing packet
4 network device
5 GMPLS controller
6 routing protocol section
7 signaling protocol section
8 scheduling controller
9 failure information notifier
10 monitor section
11 path setting manager
12 switch controller
13 switch section
14 queue A
15 queue B
16 failure information notification path
17 switch
18 communication path A
19 communication path B
20 transmitter/receiver
21 group of control modules
22 in-band control channel separator
N1 to N5 node devices
P1 current path
P2 auxiliary path

### BEST MODE FOR CARRYING OUT THE INVENTION

Next, the best mode for carrying out the present invention will be explained in details by making a reference to the accompanied drawings.

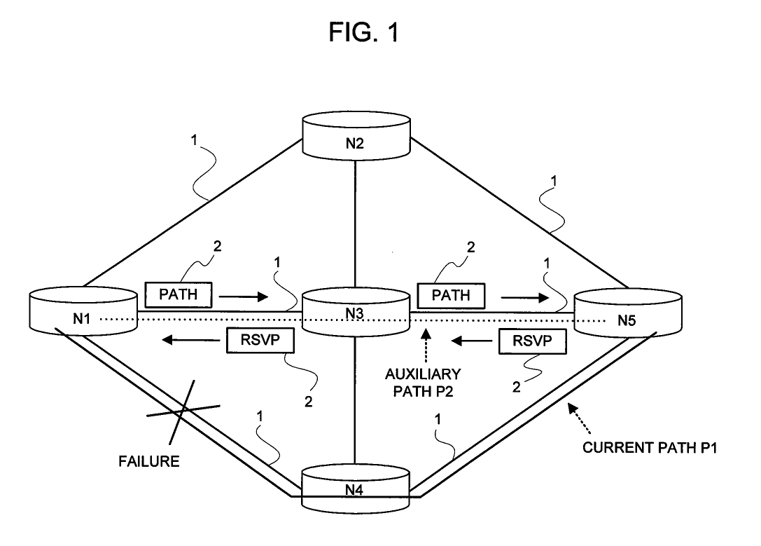

At first, an embodiment of the first failure recovery method of the present invention will be explained by making a reference to FIG. 1 to FIG. 3.

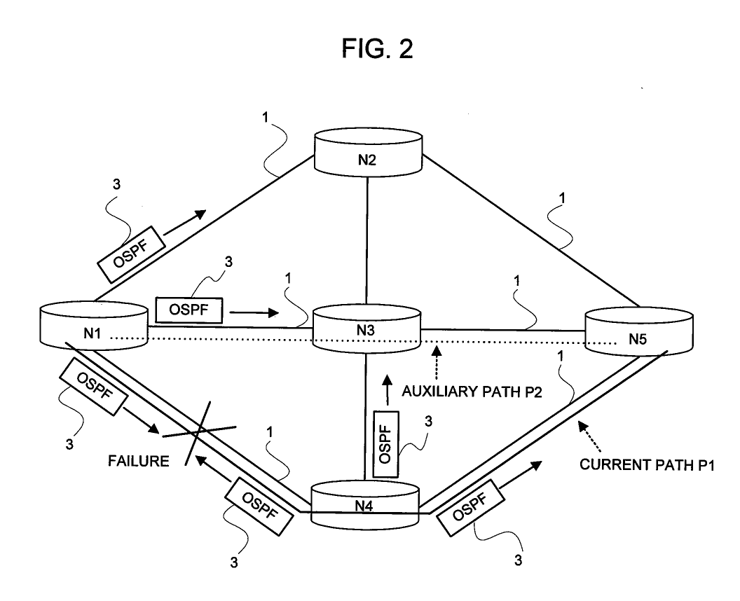

FIG. 1 is an explanatory view of an operation of the signaling protocol in a GMPLS network in which steps of the first failure recovery method of the present invention are performed, and FIG. 2 is an explanatory view of an operation of the routing protocol likewise. In FIG. 1 and FIG. 2, each of N1 to N5 signifies a node device constituting the GMPLS network, and 1 is a link connecting respective node devices N1 to N5. Any communicable line such as an optical fiber and an Ethernet (Registered Trademark) cable can be employed for the link 1.

In the GMPLS network shown in FIG. 1 and FIG. 2, a N1-N4-N5 path, that is, the path that is composed of the link between the node device N1 and the node device N4, and the link between the node device N4 and the node device N5 is determined as a current path P1. Herein, the so-called path, which is a virtual connection, specifically, signifies a LSP (Label Switching Path). Further, the failure recovery type of this current path P1 is a type of 1:1 of the pre-planned recovery/path failure recovery technique, and an N1-N3-N5 path is determined as an auxiliary path that is used instead of its current path 1 when the failure occurs in the current path P1. Herein, in FIG. 1 and FIG. 2, it is the node device N1, being a start-point node of the path, that stores the fact that the auxiliary path for the current path P1 is P2. Additionally, only one current path, being P1, is determined in the GMPLS network shown in FIG. 1 and FIG. 2; however a plurality of the current paths, i.e. two or more may be determined. In this case, the Shared type of the pre-planned recovery/path failure recovery technique may be used to allow two current paths to share the identical auxiliary path.

A signaling packet 2 shown in FIG. 1, which is a packet for switching the path at the time of occurrence of the failure, is transferred from the start-point node device N1 up to the end-point node device N5 of the auxiliary path P2. Further, a routing packet 3 shown in FIG. 2 is a packet that is published to the neighboring node for the purpose of updating a link state due to a change in the link state caused by the failure at the time of occurrence of the failure, and yet a packet by a link-state type routing protocol, i.e. an OSPF protocol, or a packet by the routing protocol obtained by extending it for the GMPLS. In the GMPLS network, a data plane for transferring a data packet and a control plane for transferring control packets such as the signaling packet 2 and the routing packet 3 are logically separated.

Next, an operation of this embodiment in the case that the failure has occurred in some link constituting the current path P1 will be explained in details. Herein, the case that the failure has occurred in the link 1 connecting the node device N1 and the node device N4 is envisaged.

When a failure occurs in some link constituting the current path P1 in the GMPLS network shown in FIG. 1 and FIG. 2, its failure, which is detected in the node devices at both ends of its link, is notified to the control plane of the node device. In this-time case, it is assumed that the failure has occurred in the link between the node device N1 and the node device N4, whereby the failure is detected in the node device N1 and the node device N4, and is notified to the control plane of the node device N1 and the node device N4.

In this example, the node device N1 itself, being a start-point node of the current path P1, was able to detect the failure of the link constituting the current path P1; however in a case where the current path P1 fails due to the failure of the link between the node device N4 and the node device N5, such a failure of the data plane is ultimately notified to the node device N1, being a start-point node of the current path P1. There exist two kinds of the methods for notifying the failure of the data plane. One method is a method of notifying the failure by the signaling protocol over the control plane. Specifically, it is notified by using a Notify message of the RSVP. Information as to which path has failed is included in this message, so the start-point node starts an operation of switching the path that corresponds to this information. The other method is a method of notifying the failure over the data plane. Depending upon the kind of the data plane, upon exemplifying the case of a SONET/SDH, a signal that is called an AIS (Alarm Indication Signal) is caused to enter an overhead portion of the SONET/SDH. A monitor section of a switching section of the start-point node having received this information up-loads the failure information of the path onto the control plane, and starts an operation of switching the corresponding path over the control plane.

The node device N1 and the node device N4 having detected the failure start the failure recovery, respectively. In this case, the mode device N1 is a start-point node of the current path P1, and the node device N4 is not a start-point node of the current path P1, so they operate differently from each other. Hereinafter, the operations of the node device N1 and the node device N4 will be explained, respectively.

At first, the failure recovery operation of the node device N1, being a start-point node of the current path P1, will be explained. Upon detecting the failure of the link between the node device N1 and the node device N4, the node device N1 transmits the signaling packet 2 by the signaling protocol of the node device N1, which is called a Path message, through the node device N3 to the node device N5, being an end-point node of the auxiliary path P2, for the purpose of switching the current path P1 using its link to the auxiliary path P2. Further, the node device N1 has to transmit the routing packet for updating a change in the link state to other node device because the failure has occurred in the link between the node device N1 and the node device N4; however in this embodiment, the node device N1 starts to transmit the routing packet by the routing protocol after finishing a switchover of the path by the signaling protocol because starting the transmission of the routing packet simultaneously with the transmission of the signaling packet allows the failure recovery time to be influenced due to a competition between the packets.

The Path message by the signaling packet 2 requests the node over the failure recovery path of the auxiliary path P2 to set a label that is affixed link by link. The Path message is sent out to the node device N5 through the node device N3, being a relaying device. The node device N3 having received the Path message sets the switch in order to use the auxiliary path P2. Thereafter, the node device N3 sends out the Path message to the node device N5. The node device N5 having received the Path message determines that the received message is a packet addressed to its own node, and transmits the signaling packet 2 that is called a Resv message through the path opposite to that of the Path message to the node device N3 after setting the switch. After the node device N3 having received the Resv message changes label information within the Resv message, it sends out the Resv message to the node device N1. The node device N1 having received the Resv message, thereafter, transmits the packet, which was transmitted so far to the current path P1, to the auxiliary path P2 because the auxiliary path P2 has been determined. This means that the switchover of the failed current path P1 to the auxiliary path P2 has been completed.

In FIG. 1 and FIG. 2, the node device N1 starts to transmit the routing packet after finishing a switchover of the failed current path P1 to the auxiliary path P2 because there exists no failed path, which has the node device N1 assumed to be a start-point node, other than the one current path P1. If there exist a plurality of the failed paths having the node device N1 assumed to be a start-point node, the node device N1 switches the all failed paths to the auxiliary path in a similar method to that of the case of having switched the failed current path P1 to the auxiliary path P2. And, the node device N1 confirms the transmitted Path message and the received Resv message, thereby to determine that the failed paths have been all switched, and when the all failed paths are switched, it starts a publication of the failed link by the routing packet.

The routing protocol in the node device N1 transmits a routing packet 3 to the node device N2, the node device N3, and the node device N4 in order to update a change in the state of the failed link. The node device N2 having received the routing packet 3 transmits the routing packet 3 to the node device N3 and the node device N5. Thereafter, similarly hereto, the routing packet 3 for updating a change in the state of the failed link is sequentially transferred. Each node device having received the routing packet 3 performs an operation specified by the routing protocol, for example, an update of a topology database. When the topology databases of all node devices of the network are updated, the failure recovery operation initiated after occurrence of the failure is finished.

Next, the failure recovery operation of the node device N4, being a relaying node of the current path P1, will be explained. Upon detecting the failure of the link 1 between the node device N4 and the node device N1, the node device N4 determines that the failure has occurred in the current path P1 using its link 1. However, the node device N4 does not execute such a failure recovery operation by the signaling protocol that the foregoing node device N1 executed because the start-point node of the current path P1 is not its own node device N4, and yet, there exists no failed path in which its own node device N4 becomes a start-point node.

On the other hand, the node device N4, which has detected the failure of the link between the node device N4 and the node device N1, has to transmit the routing packet for updating a change in the link state to other node device according to the routing protocol. However, starting to unconditionally transmit the routing packet causes the routing packet to compete with the signaling packet that the node device N1, being a start-point node of the failed path, transmits for the purpose of switching the failed path, which exerts an influence upon the failure recovery time. Thereupon, the node device N4 starts to transmit the routing packet by the routing protocol after finishing a switchover of the failed current path 1. As described before, when a switchover of the current path P1 to the auxiliary path P2 is finished, the node device N1 comes to transmit the routing packet by the publication of the failed link to its own node device N4, whereby it is possible to determine whether a switchover of the current path P1 has been finished on the basis of reception of such a routing packet from the node device N1.

In FIG. 1 and FIG. 2, when the node device N4 finished a switchover of the failed current path P1 to the auxiliary path P2, it started to transmit the routing packet because there existed no failed path, which had the node device N4 assumed to be a relaying node, other than the one current path P1; however in a case where there exist a plurality of the failed paths having the node device N4 assumed to be a relaying node, the node device N4 starts to transmit the routing packet at the time point of having detected a switchover of the all failed paths to the auxiliary path on the basis of reception of the routing packet from each start-point node.

Next, an effect of this embodiment will be explained.

In this embodiment, at the time of the failure of the current path P1, the node device N1, being a start-point node of the current path P1, starts the publication of the link state by the routing protocol with it as a turning point that a switchover of the current path P1 to the auxiliary path P2 has been finished, that is, with it as a turning point that one round-trip of the signaling message for switching the failed path along a failure recovery path (N1-N3-N5) has been confirmed, thereby enabling the congestion state due to a competition between the signaling packet and the routing packet to be avoided, and enabling the pre-planned failure recovery time to be reduced. Further, the congestion state of the signaling packet and the routing packet is avoided, thereby making it possible to lower a probability that the signaling packet is cancelled, and to enhance a reliability of the failure recovery.

Further, in this embodiment, the node device N4 that is not a start-point node of the current path P1 starts the publication of the failed link by the routing protocol with it as a turning point that the node device N1, being a start-point node of the current path P1, has finished a switchover of the current path P1 to the auxiliary path P2, that is, with it as a turning point that the node device N4 has received the routing packet by the publication of the failed link from the node device N1, thereby enabling a competition between the signaling packet and the routing packet, and the congestion state to be avoided all the more.

Next, a modification example of this embodiment will be explained.

In this example, it was assumed that in a case where a plurality of the failed paths in which its own node device N1 became a start-point node existed, the node device N1 started the publication of the failed link by the routing protocol after finishing a switchover of the all failed paths; however the node device N1 may start the publication of the failed link by the routing protocol at the time point of having finished a switchover of one part of the all failed paths. Specifically, the node device N1 starts to transmit the routing packet with it as a turning point that one round-trip of the signaling message for switching one part of the failed path along the failure recovery path has been confirmed.

In this embodiment, it was assumed that in a case where a plurality of the failed path in which its own node device N4 became a relaying node existed, the node device N4 started the publication of the failed link by the routing protocol after finishing a switchover of the all failed paths; however the node device N4 may start the publication of the failed link by the routing protocol at the time point of having finished a switchover of one part of the all failed paths.

In this embodiment, it was assumed that in a case where one or more failed paths in which its own node device N1 became a start-point node existed, the node device N1 started the publication of the failed link by the routing protocol after finishing a switchover of the all failed paths; however the node device N1 may start to transmit the routing packet with it as a turning point that the transmission of the signaling message for switching the all or one part of the failed paths by the signaling protocol has been finished.

Next, an embodiment of the network control device that is used in the first failure recovery method of the present invention will be explained in details by making a reference to the accompanied drawings.

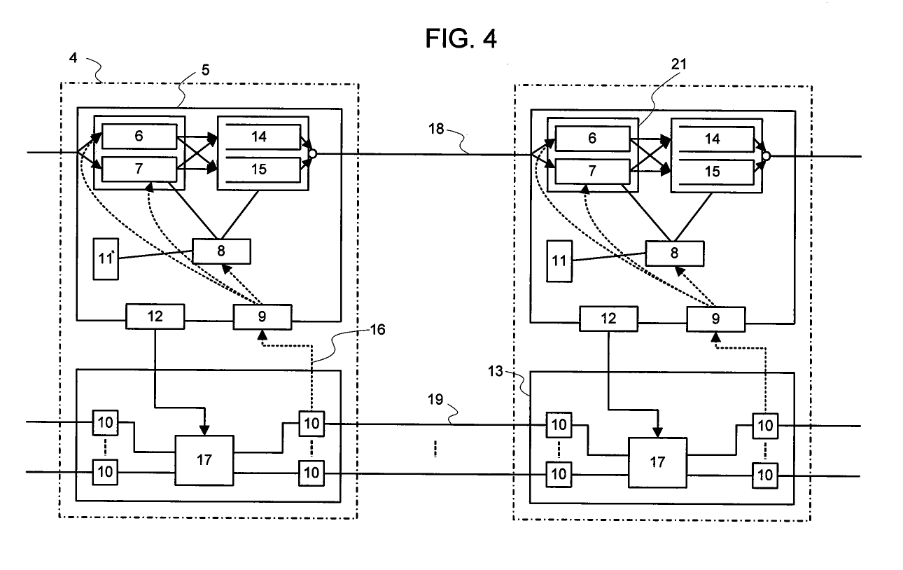

Upon making a reference to FIG. 4, a network device 4 relating to this embodiment is configured of a GMPLS controller 5 constituting the control network, and a switch section 13 constituting the network of the data plane. The network device 4 shown in this FIG. 4 is used as the node device (node devices N1 to N5 of FIG. 1 and FIG. 2) in the GMPLS network in which the steps of the first recovery method of the present invention explained by making a reference to FIG. 1 to FIG. 3 are performed.

The GMPLS controller 5 includes a group of control modules 21 having a routing protocol section 6 and a signaling protocol section 7, a queue A 14 and a queue B 15, a scheduling controller 8, a path setting manager 11, a failure information notifier 9, a switch controller 12, and a communication path A 18 with the GMPLS controller 5 of the other network device 4. Further, the switch section 13 includes a switch 17 for transferring the data packet, a monitor section 10 for detecting the link failure etc., and a communication path B 19 with the switch section 13 of the other network device 4. Roughly speaking, each of these elements has the following function.

The switch 17 transfers the data packet transmitted from the other network device to the yet other network, that is, performs a process of switching a route.

The communication path B 19 is a communication path for transferring the data packet for which the data transfer process has been performed in the switch 17 to a transmission destination.

The monitor section 10 monitors whether the failure has occurred in the link over the communication path B 19 and the other network device (node device) connected via its link, and upon detecting the failure of the link or the other node device, the monitor section 10 sends out failure information including information etc. of the location in which the failure has occurred to the failure information notifier 9.

The switch controller 12 controls the switch 17 within the switch section 13.

The failure information notifier 9 receives failure information that is notified from the monitor section 10 within the switch section 13, and notifies its failure information to the routing protocol section 6, the signaling protocol section 7, and the scheduling controller 8.

In a case where the network normally operates, the routing protocol section 6 does not use the queue B 15, but uses only the queue A 14, thereby to make a topology exchange with the neighboring node, and to carry out a preparation of the routing table, a publication of a TE link (Traffic Engineering Link), an exchange of a Hello packet for maintaining a relation with the neighboring node, or the like. Further, when the routing protocol section 6 is notified of the failure information from the failure information notifier 9, i.e. at the time of the failure, the former carries out an update of the link state information, an exchange of the Hello packet for maintaining a relation with the neighboring node similarly to the case that the network normally operates, or the like. At the time of this failure, the routing protocol section 6 uses the queue A 14 for the purpose of transmitting the Hello packet, and uses the queue B 15 for the routing packet for updating link state information other than the Hello packet, or the like.

In a case where the network normally operates, the signaling protocol section 7 uses the queue A 14, thereby to carry out a setting of the LSP, a deletion of the LSP, a management of the setting state of the LSP, or the like. Further, when the signaling protocol section 7 is notified of the failure information from the failure information notifier 9, i.e. at the time of the failure, if the notified failure is a failure of the current path having its own network device assumed to be a start-point node, the former uses the queue A 14, thereby to switch the failed path to the auxiliary path. The signaling protocol section 7, in a case where its own network device becomes a relaying node or an end-point node of the auxiliary path, transmits the Path message received from the node device that becomes a start-point node, or the Resv message that is an answer hereto to the next node device over the failure recovery path, and the packets also relevant to such messages are filed into the queue A 14. The signaling protocol section 7 never uses the queue B 15 not only in a normal state and but also in a failure state.

Accordingly, the queue A 14 is used for filing the packet transmitted from the routing protocol section 6 and the packet transmitted from the signaling protocol section 7 in a case where the network normally operates, and is used for filing the packet that is transmitted from the signaling protocol section 7 and the Hello packet that is transmitted from the routing protocol section 6 at the time of occurrence of the failure. Further, the queue B 15 is not used in a case where the network normally operates, but is used for filing the packets other than the Hello packet that are transmitted from the routing protocol section 6 at the time of occurrence of the failure.

The scheduling controller 8 performs a transmission process of the packets filed into the queue A 14 and the queue B 15. The scheduling controller 8 performs a transmission process of the packets filed into the queue A 14 in the order in which they have been filed in a case where the network normally operates. Further, when the scheduling controller 8 is notified of the failure information from the failure information notifier 9, i.e. at the time of the failure, the former performs a transmission process of the packets, to begin with the packets in the queue A 14, notifies to the path setting manager 11 the effect that the transmission process of the packets in the queue A 14 has been finished upon finishing the transmission process of the packets in the queue A 14, performs a transmission process of the packets in the queue B 15 upon receiving the notification saying the effect that a switchover of the all failed paths has been finished from the path setting manager 11, and is exclusively engaged in the transmission process of the packets in the queue A 14 unless it receives such a notification.

The path setting manager 11 monitors a situation of a switchover of the failed path to the auxiliary path by the signaling protocol section 7, and upon detecting that a switchover of the all failed path to the auxiliary path has been finished, the former notifies its effect to the scheduling controller 8.

Next, an operation of the network device 4 relevant to this embodiment will be explained in details. In the first place, the operation of the case that the network normally operates will be explained by making a reference to a block diagram of FIG. 4.

In a case where that the network normally operates, the routing protocol section 6 makes a topology exchange with the neighboring node, and transmits/receives the packets for the purpose of preparing the routing table, publishing the TE link, exchanging the Hello packet for maintaining a relation with the neighboring node, or the like. The packets that are transmitted from the routing protocol section 6 are filed into the queue A 14. Further, the signaling protocol section 7 transmits/receives the packets for the purpose of setting the LSP, deleting the LSP, managing the setting state of the LSP, and the like. Likewise, the packets also that are transmitted from the signaling protocol section 7 are filed into the queue A 14. In this case, the queue B 15 is not used. Herein, assuming that each of the queue A 14 and the queue B 15 is a variable-length queue and an identical memory region is used makes it possible to avoid waste of the memory not only in the case that the network normally operates, but also in the case of the failure time.

The packets filed into the queue A 14 are transmission-processed by the scheduling controller 8. The packets are transmission-processed in the order in which they have been filed into the queue A 14. The packets for which the transmission process has been completed within the queue A 14 are transferred to a transmission destination by using a communication path A 18.

On the other hand, the switch 17 of the switch section 13 transfers the data packet under control of the switch controller 12.

The operation of the case that the network normally operates is one described above.

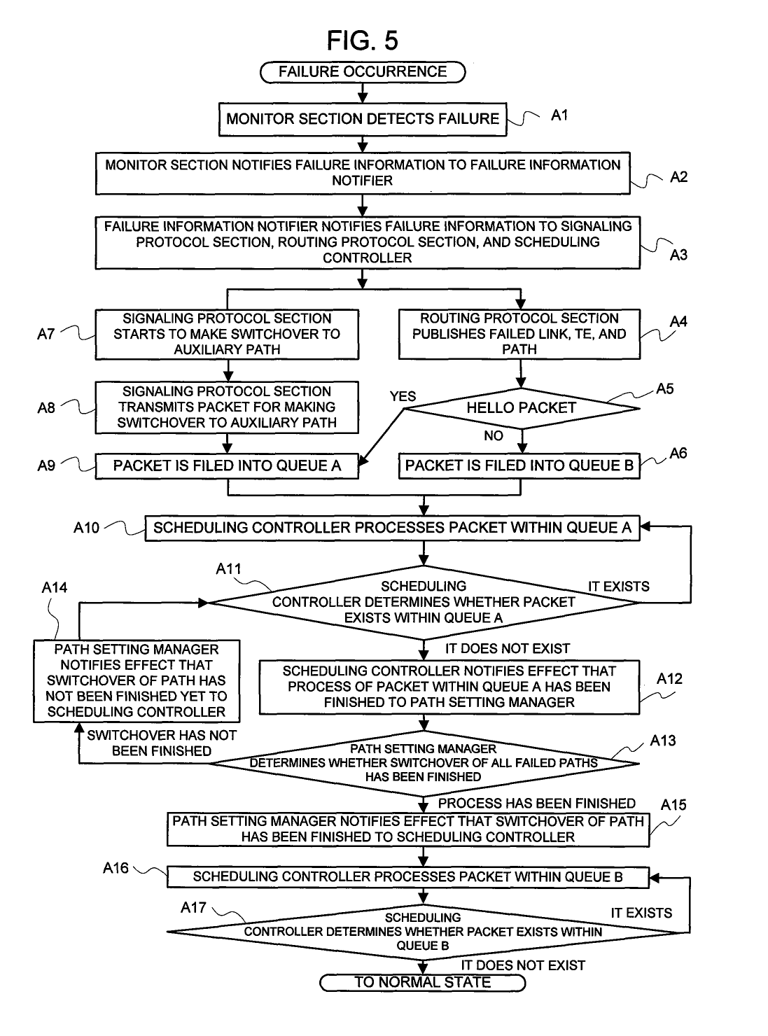

Next, an operation of the network device (equivalent to the node device N1 in the case of FIG. 1 and FIG. 2) having detected the failure of the current path in which its own network device becomes a start-point node will be explained by making a reference to a block diagram of FIG. 4 and a flowchart of FIG. 5.

When a failure occurs in the link over the communication path B 19 or the other network device (node device) connected via the communication path B 19, the monitor section 10 of the network device 4 detects its failure (step A1 of FIG. 5). The monitor section 10 having detected the failure notifies failure information to the failure information notifier 9 (step A2). The failure information notifier 9 having received the failure information simultaneously transmits the failure information to the routing protocol section 6, the signaling protocol section 7, and the scheduling controller 8 (step A3).

The routing protocol section 6 having received the failure information from the failure information notifier 9 transmits the packet relevant to the link state information for the purpose of updating the link state (step A4). The packet relevant to the link state information transmitted from the routing protocol section 6 is filed into the queue B 15 (step A6). Further, the routing protocol section 6 regularly transmits/receives the Hello packet for maintaining a relation with the neighboring node. The Hello packet that is transmitted from the routing protocol section 6 is filed into the queue A 14 (step A9).

On the other hand, the signaling protocol section 7 having received the failure information from the failure information notifier 9 starts to switch the failed path to the auxiliary path (step A7), and transmits the packet for making a switchover to the auxiliary path (step A8). The packet for switching the failed path to the auxiliary path transmitted from the signaling protocol section 7 is filed into the queue A 14 (step A9).

The scheduling controller 8 having received the failure information monitors the queue A 14 and the queue B 15, and upon detecting that the packet exists in the queue A 14, it performs a transmission process of its packet (step A10). Upon finishing the transmission process of one packet within the queue A 14, the scheduling controller 8 determines existence of the packet within the queue A 14 (step A11), and if it determines that the packet exists within the queue A 14, it performs a transmission process of the packet again. If the scheduling controller 8 determines that no packet exists within the queue A 14, it notifies the effect that the process of the packet within the queue A 14 has been finished to the path setting manager 11 (step A12).

The path setting manager 11 having received the notification saying that the transmission of the packet within the queue A 14 has been finished determines whether a switchover of the all failed paths to the auxiliary path has been finished (step A13). The path setting manager 11 determines that a switchover of the all failed paths, in which its own network device becomes a start-point node, to the auxiliary path has been finished in a case where the signaling packet relevant to the Resv message has been received for the signaling packet relevant to the Path message transmitted from the signaling protocol section 7. And, if the path setting manager 11 determines that a switchover of the all failed paths to the auxiliary path has not been finished yet, it notifies the effect that a switchover of the all failed paths to the auxiliary path has not been finished yet to the scheduling controller 8 (step A14). The scheduling controller 8 having received the notification saying that a switchover to the auxiliary path has not been finished yet confirms existence of the packet within the queue A 14 again, and performs a transmission process again if it confirms that the packet exists.

On the other hand, if the path setting manager 11 determines that a switchover of the all failed paths to the auxiliary path has been finished, it notifies the effect that a switchover of the all paths has been finished to the scheduling controller 8 (step A15). The scheduling controller 8 having received the notification saying that a switchover to the auxiliary path has been finished performs a transmission process of the packet within the queue B 15 (step A16). Upon finishing the transmission process of the packet within the queue B 15, the scheduling controller 8 determines existence of the packet within the queue B 15 (step A17), and if it determines that the packet exits, it performs a transmission process of the packet again, and if it determines that no packet exits, the failure recovery operations by the routing protocol section 6 and the signaling protocol section 7 are finished.

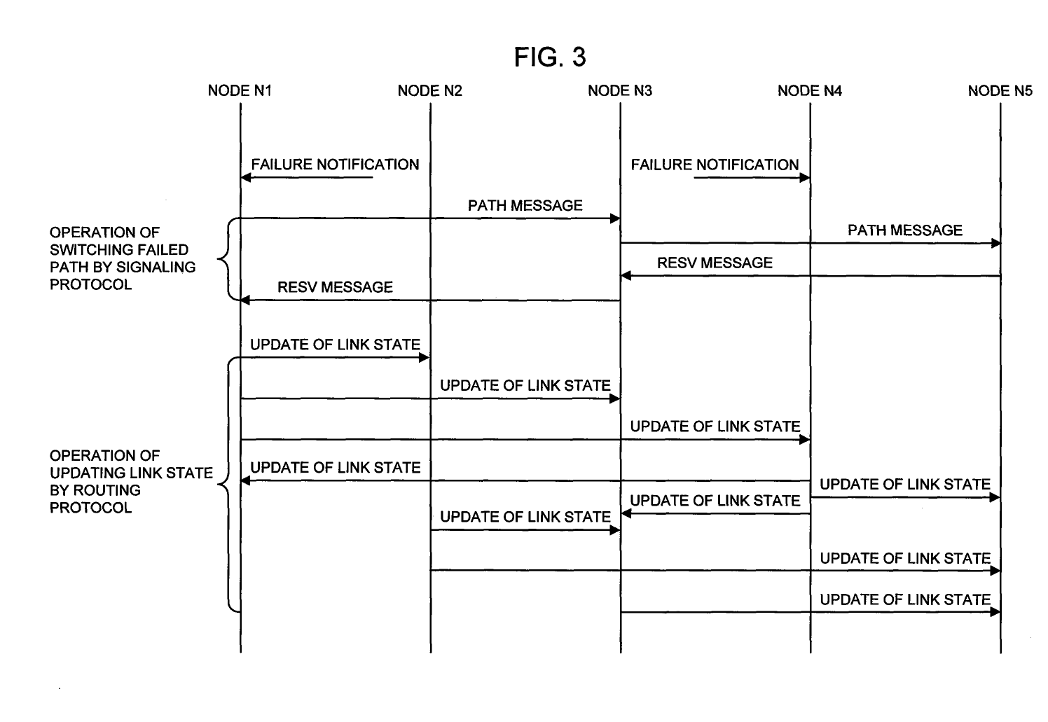

Performing such an operation makes it possible to start the publication by the routing protocol with it as a turning point that a switchover of the current path to the auxiliary path has been finished, thereby to avoid occurrence of a competition between the signaling packet and the routing packet and a congestion state, and to reduce the pre-planned failure recovery time in the network device (equivalent to the node device N1 of the case of FIG. 3) having detected the failure of the current path in which its own network device becomes a start-point node. Further, the congestion state of the routing packet and the signaling packet is avoided, thereby making it possible to lower a probability that the signaling packet is canceled, and to enhance a reliability of the failure recovery.

Next, an operation of the network device (equivalent to the node device N4 of the case of FIG. 1 and FIG. 2) having detected the failure of the current path in which its own network device becomes a relaying node will be explained by making a reference to the block diagram of FIG. 4 and the flowchart of FIG. 5.

When a failure occurs in the link over the communication path B 19 or the other network device (node device) connected via the communication path B 19, the monitor section 10 of the network device 4 detects its failure (step A1 of FIG. 5). The monitor section 10 having detected the failure notifies failure information to the failure information notifier 9 (step A2). The failure information notifier 9 having received the failure information simultaneously transmits the failure information to the routing protocol section 6, the signaling protocol section 7, and the scheduling controller 8 (step A3).

The routing protocol section 6 having received the failure information from the failure information notifier 9 transmits the packet relevant to the link state information for the purpose of updating the link state (step A4). The packet relevant to the link state information transmitted from the routing protocol section 6 is filed into the queue B 15 (step A6). Further, the routing protocol section 6 regularly transmits/receives the Hello packet for maintaining a relation with the neighboring node. The Hello packet that is transmitted from the routing protocol section 6 is filed into the queue A 14 (step A9).

On the other hand, the signaling protocol section 7 having received the failure information from the failure information notifier 9 does not switch the failed path to the auxiliary path because its own network device is not a start-point node of the failed path. That is, steps A7 to A9 of FIG. 5 are skipped.

The scheduling controller 8 having received the failure information monitors the queue A 14 and the queue B 15, and upon detecting that the packet exists in the queue A 14, it performs a transmission process of its packet (step A10). Upon finishing the transmission process of one packet within the queue A 14, the scheduling controller 8 determines existence of the packet within the queue A 14 (step A11), and if it determines that the packet exists within the queue A 14, it performs a transmission process of the packet again. If the scheduling controller 8 determines that no packet exists in the queue A 14, it notifies the effect that the process of the packet within the queue A 14 has been finished to the path setting manager 11 (step A12).

The path setting manager 11 having received the notification saying that the transmission of the packet within the queue A 14 has been finished determines whether a switchover of the all failed paths to the auxiliary path has been finished (step A13). In a case where the path setting manager 11 has received the packet relevant to the publication of the all failed paths, in which its own network device becomes a relaying node, from the network device that becomes a start-point node, it determines that a switchover of the all failed paths to the auxiliary path has been finished. And, if the path setting manager 11 determines that a switchover of the all failed paths to the auxiliary path has not been finished yet, it notifies the effect that a switchover of the all failed paths to the auxiliary path has not been finished yet to the scheduling controller 8 (step A14). The scheduling controller 8 having received the notification saying that a switchover to the auxiliary path has not been finished yet confirms existence of the packet within the queue A 14 again, and performs a transmission process again if it confirms that the packet exists.

On the other hand, if the path setting manager 11 determines that a switchover of the all failed paths to the auxiliary path has been finished, it notifies the effect that a switchover of the all paths has been finished to the scheduling controller 8 (step A15). The scheduling controller 8 having received the notification saying that a switchover to the auxiliary path has been finished performs a transmission process of the packet within the queue B 15 (step A16). Upon finishing the transmission process of the packet within the queue B 15, the scheduling controller 8 determines existence of the packet within the queue B 15 (step A17), if it determines that the packet exits, it performs a transmission process of the packet again, and if it determines that no packet exits, the failure recovery operation by the routing protocol section 6 and the signaling protocol section 7 is finished.

Performing such an operation makes it possible to start the publication by the routing protocol with it as a turning point that a switchover of the current path to the auxiliary path has been finished, thereby to avoid occurrence of a competition between the signaling packet and the routing packet and a congestion state, and to reduce the pre-planned failure recovery time in the network device (equivalent to the node device N4 of the case of FIG. 3) having detected the failure of the current path in which its own network device becomes a relaying node. Further, the congestion state of the routing packet and the signaling packet is avoided, thereby making it possible to lower a probability that the signaling packet is canceled, and to enhance a reliability of the failure recovery.

Next, an effect of this embodiment will be explained. The network device 4 relevant to this embodiment, which includes two of the queue A 14 and the queue B 15, files the packet that is transmitted from the signaling protocol section 7 and the Hello packet that is transmitted from the routing protocol section 6 into the queue A 14, and files the packet other than the Hello packet of the routing protocol section 6 into the queue B 15 at the time of the failure of the current path, and processes the packet that is filed into the queue A 14 more preferentially than the packet that is filed into the queue B 15 until a switchover of the all failed paths to the auxiliary path is finished. That is, the network device 4 transmits only the packet that is filed into the queue A 14 to the communication path A 18, and thereafter, transmits the packet that is filed into the queue B 15 to the communication path A 18. This allows a competition between the packet that is transmitted from the routing protocol section 6 and the packet that is transmitted from the signaling protocol section 7 to be eliminated in the communication path A 18, thereby enabling the pre-planned failure recovery time to be reduced. In addition hereto, the possibility that the signaling packet is cancelled is eliminated, which allows a reliability of the failure recovery to be enhanced.

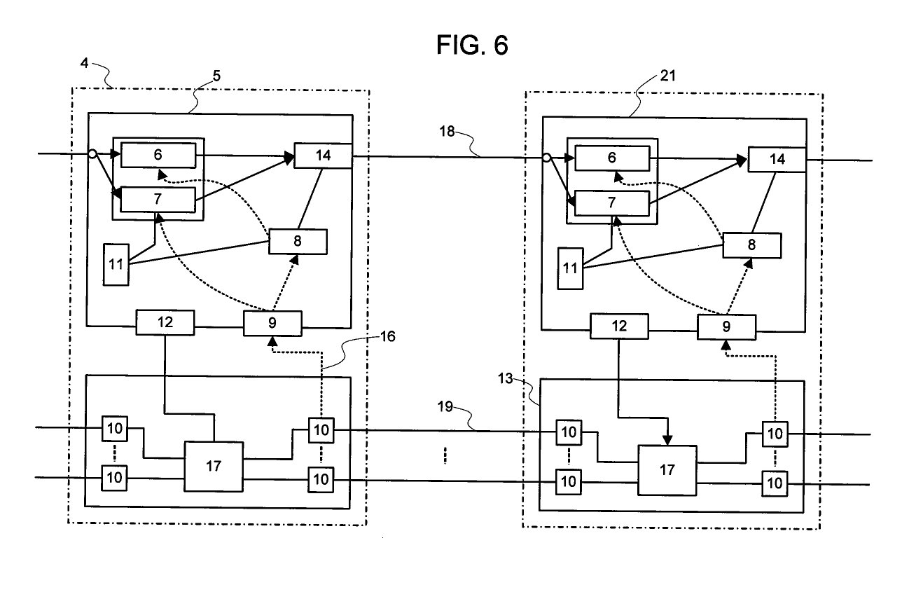

Upon making a reference to FIG. 6, a network device 4 relevant to another embodiment that is used in the first failure recovery method of the present invention is configured of a GMPLS controller 5 constituting the control network, and a switch section 13 constituting the network of the data plane. The network device 4 shown in this FIG. 6 is used as the node device (the node devices N1 to N5 of FIG. 1 and FIG. 2) in the GMPLS network in which the steps of the first failure recovery method of the present invention explained by making a reference to FIG. 1 to FIG. 3 are performed.

The GMPLS controller 5 includes a group of control modules 21 having a routing protocol section 6 and a signaling protocol section 7, a queue A 14, a scheduling controller 8, a path setting manager 11, a failure information notifier 9, a switch controller 12, and a communication path A 18 with the GMPLS controller 5 of the other network device 4. Further, the switch section 13 includes a switch 17 for transferring the data packet, a monitor section 10 for detecting the link failure etc., and a communication path B 19 with the switch section 13 of the other network device 4. A major difference with the network device 4 explained in FIG. 4 lies in a point that the queue B 15 is omitted, and information of the failure detected in the monitor section 10 is notified to the signaling protocol section 7 in the first place, and the failure information is notified to the routing protocol section 6 at the time point that a switchover of the all failed paths to the auxiliary path has been finished. Roughly speaking, each component of the GMPLS controller 5 and the switch section 13 has the following function.

The switch 17 performs a process for transferring the data packet transmitted from the other network device to the yet other network device.

The communication path B 19 is a communication path for transferring the data packet for which the data transfer process has been performed in the switch 17 to a transmission destination.

The monitor section 10 monitors whether the failure has occurred in the link over the communication path B 19 and the other network device (node device) connected via its link, and upon detecting the failure of the link or the other node device, the monitor section 10 sends out failure information including information etc. of the location in which the failure has occurred to the failure information notifier 9.

The switch controller 12 controls the switch 17 within the switch section 13.

The failure information notifier 9 receives failure information that is notified from the monitor section 10 within the switch section 13, and notifies its failure information to the signaling protocol section 7 and the scheduling controller 8. At this time point, no failure information is notified to the routing protocol section 6.

In a case where the network normally operates, the routing protocol section 6 makes a topology exchange with the neighboring node, and carries out a preparation of the routing table, a publication of the TE link, an exchange of the Hello packet for maintaining a relation with the neighboring node, or the like. Further, in a case where the routing protocol section 6 is notified of the failure information detected in the monitor section 10, it starts to transmit the packet for updating the link state information simultaneously with making an exchange of the Hello packet for maintaining a relation with the neighboring node or the like, similarly to the case that the network normally operates.

In a case where the network normally operates, the signaling protocol section 7 carries out a setting of the LSP, a deletion of the LSP, a management of the setting state of the LSP, or the like. Further, when the signaling protocol section 7 is notified of the failure information from the failure information notifier 9, i.e. at the time of the failure, the former switches the failed path to the auxiliary path if the notified failure is a failure of the current path having its own network device assumed to be a start-point node. Further, the signaling protocol section 7, in a case where the its own network device becomes a relaying node or an end-point node of the auxiliary path, transmits the Path message received form the node device that becomes a start-point node, or the Resv message that is an answer hereto to the next node device over the failure recovery path.

The queue A 14 is used for filing the packet transmitted from the routing protocol section 6 and the packet transmitted from the signaling protocol section 7.

The scheduling controller 8 performs a transmission process of the packets filed into the queue A 14. The scheduling controller 8 performs a transmission process of the packets filed into the queue A 14 in the order in which they have been filed. Further, when the scheduling controller 8 is notified of the failure information by the failure information notifier 9, i.e. at the time of the failure, upon finishing the transmission process of the packets within the queue A 14, it notifies the effect that the transmission process of the packet within the queue A 14 has been finished to the path setting manager 11, and upon receiving the notification saying the effect that a switchover of the all failed paths has been finished from the path setting manager 11, it notifies the failure information notified from the failure information notifier 9 to the routing protocol section 6, performs a transmission process of the packets within the queue A 14 again, and performs a transmission process of the packets within the queue A 14 again without notifying the failure information to the routing protocol section 6 unless it receives such a notification.

The path setting manager 11 monitors a situation of a switchover of the failed path to the auxiliary path by the signaling protocol section 7, and upon detecting that a switchover of the all failed path to the auxiliary path has been finished, it notifies its effect to the scheduling controller 8.

Next, an operation of the network device 4 relevant to this embodiment will be explained in details. In the first place, the operation of the case that the network normally operates will be explained by making a reference to a block diagram of FIG. 6.

In a case where that the network normally operates, the operation similar to that of the network device 4 relevant to the embodiment of FIG. 4 is performed as follows. The routing protocol section 6 makes a topology exchange with the neighboring node, and transmits/receives the packets for the purpose of preparing the routing table, publishing the TE link, exchanging the Hello packet for maintaining a relation with the neighboring node, or the like. The packets that are transmitted from the routing protocol section 6 are filed into the queue A 14. Further, the signaling protocol section 7 transmits/receives the packets for the purpose of setting the LSP, deleting the LSP, managing the setting state of the LSP, and the like. Likewise, the packets as well that are transmitted from the signaling protocol section 7 are filed into the queue A 14.

The packets filed into the queue A 14 are transmission-processed by the scheduling controller 8. The packets are transmission-processed in the order in which they have been filed queue A 14. The packet for which the transmission process has been completed within the queue A 14 is transferred to a transmission destination by using the communication path A 18.

On the other hand, the switch 17 of the switch section 13 transfers the data packet under control of the switch controller 12.

The operation of the case that the network normally operates is one described above.

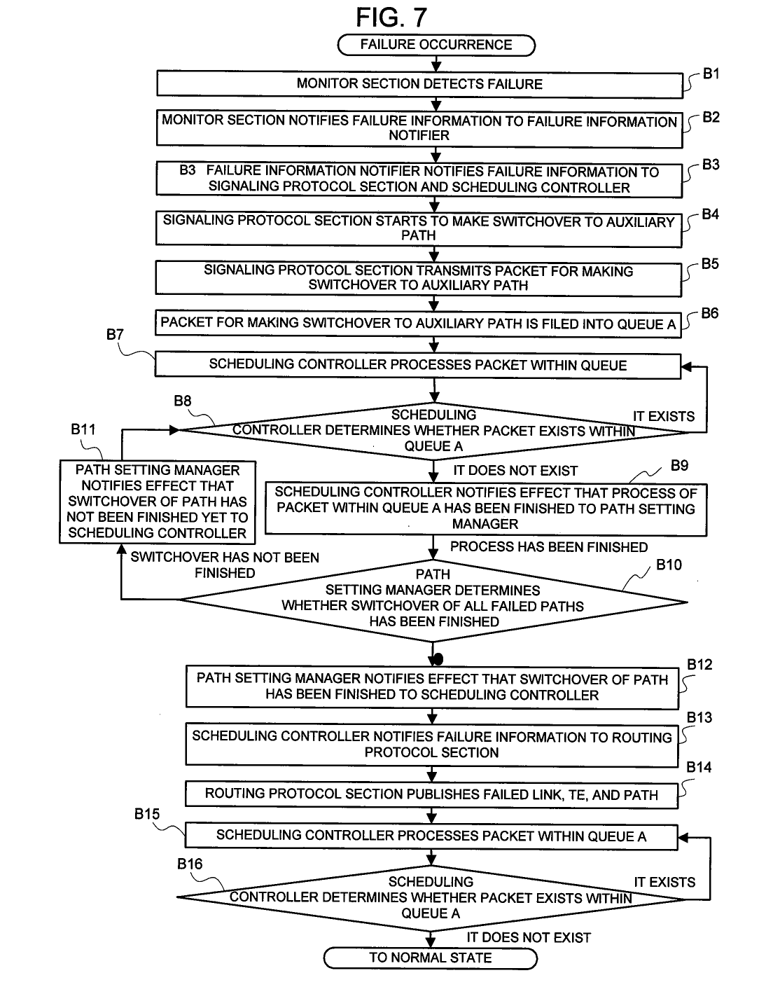

Next, an operation of the network device (equivalent to the node device N1 in the case of FIG. 1 and FIG. 2) having detected the failure of the current path in which its own network device becomes a start-point node will be explained by making a reference to a block diagram of FIG. 6 and a flowchart of FIG. 7.

When a failure occurs in the link over the communication path B 19 or the other network device (node device) connected via the communication path B 19, the monitor section 10 of the network device 4 detects its failure (step B1 of FIG. 5). The monitor section 10 having detected the failure notifies the failure information to the failure information notifier 9 (step B2). The failure information notifier 9 having received the failure information transmits the failure information to the signaling protocol section 7 and the scheduling controller 8 (step B3).

The signaling protocol section 7 having received the failure information from the failure information notifier 9 starts to switch the failed path to the auxiliary path (step B4), and transmits the packet for making a switchover to the auxiliary path (step B5). The packet for switching the failed path to the auxiliary path transmitted by the signaling protocol section 7 is filed into the queue A 14 (step B6).

On the other hand, the routing protocol section 6 has not recognized occurrence of the failure because the failure information has not been notified yet hereto, so it continues the operation of the case that the network normally operates.

The scheduling controller 8 having received the failure information monitors the queue A 14 similarly to the case that the network normally operates, and upon detecting that the packet exists in the queue A 14, it performs a transmission process of its packet (step B7). Upon finishing the transmission process of one packet within the queue A 14, the scheduling controller 8 determines existence of the packet within the queue A 14 (step B8), and if it determines that the packet exists within the queue A 14, it performs a transmission process of the packet again. If the scheduling controller 8 determines that no packet exists within the queue A 14, it notifies the effect that the process of the packet within the queue A 14 has been finished to the path setting manager 11 (step B9).

The path setting manager 11 having received the notification saying that the transmission process of the packet within the queue A 14 has been finished determines whether a switchover of the all failed paths to the auxiliary path has been finished (step B10). The path setting manager 11 determines that a switchover of the all failed paths, in which its own network device becomes a start-point node, to the auxiliary path has been finished in a case where the signaling packet relevant to the Resv message has been received for the signaling packet relevant to the Path message transmitted from the signaling protocol section 7. And, if the path setting manager 11 determines that a switchover of the all failed paths to the auxiliary path has not been finished yet, it notifies the effect that a switchover of the all failed paths to the auxiliary path has not been finished yet to the scheduling controller 8 (step B11). The scheduling controller 8 having received the notification saying that a switchover to the auxiliary path has not been finished yet confirms existence of the packet within the queue A 14 again, and performs a transmission process again if it confirms that the packet exists.

On the other hand, if the path setting manager 11 determines that a switchover of the all failed paths to the auxiliary path has been finished, it notifies the effect that a switchover of the all paths has been finished to the scheduling controller 8 (step B12). The scheduling controller 8 having received the notification saying that a switchover to the auxiliary path has been finished notifies the failure information notified from the failure information notifier 9 to the routing protocol section 6 (step B13). Additionally, the failure information was notified to the routing protocol section 6 from the scheduling controller 8; however it is also possible to employ the method in which the failure information is notified from the path setting manager 11 or the failure information notifier 9, the method in which the path setting manager 11 notifies the effect that a switchover of the all paths has been finished to the signaling protocol section 7 as well and the signaling protocol section 7 notifies the failure information notified from the failure information notifier 9 to the routing protocol section 6, or the like.

The routing protocol section 6 having received the failure information from the failure information notifier 9 transmits the packet relevant to the link state information for the purpose of updating the link state (step B14). The packets relevant to the link state information transmitted from the routing protocol section 6 are filed into the queue A 14, and are processed by the scheduling controller 8 (step B15). Upon finishing the transmission process of one packet within the queue A 14, the scheduling controller 8 determines existence of the packet within the queue A 14 (step B16), if it determines that the packet exits, it performs a transmission process of the packet again, and if it determines that no packet exits, the failure recovery operations by the routing protocol section 6 and the signaling protocol section 7 are finished.

Performing such an operation makes it possible to start the publication by the routing protocol with it as a turning point that a switchover of the current path to the auxiliary path has been finished, thereby to avoid occurrence of a competition between the signaling packet and the routing packet and a congestion state, and to reduce the pre-planned failure recovery time in the network device (equivalent to the node device N1 of the case of FIG. 3) having detected the failure of the current path in which its own network device becomes a start-point node. Further, the congestion state of the routing packet and the signaling packet is avoided, thereby making it possible to lower a probability that the signaling packet is canceled, and to enhance a reliability of the failure recovery.

Next, an operation of the network device (equivalent to the node device N4 of the case of FIG. 1 and FIG. 2) having detected the failure of the current path by itself in which its own network device becomes a relaying node will be explained by making a reference to a block diagram of FIG. 6 and a flowchart of FIG. 7.

When a failure occurs in the link over the communication path B 19 or the other network device (node device) connected via the communication path B 19, the monitor section 10 of the network device 4 detects its failure (step B1 of FIG. 7). The monitor section 10 having detected the failure notifies failure information to the failure information notifier 9 (step B2). The failure information notifier 9 having received the failure information transmits the failure information to the signaling protocol section 7 and the scheduling controller 8 (step B3).

The signaling protocol section 7 having received the failure information from the failure information notifier 9 does not switch the failed path to the auxiliary path because its own network device is not a start-point node of the failed path. That is, steps B4 to B6 of FIG. 7 are skipped.

The scheduling controller 8 having received the failure information monitors the queue A 14 similarly to the case that the network is normal, and upon detecting that the packet exists in the queue A 14, it performs a transmission process of its packet (step B7). Upon finishing the transmission process of one packet within the queue A 14, the scheduling controller 8 determines existence of the packet within the queue A 14 (step B8), and if it determines that the packet exists within the queue A 14, it performs a transmission process of the packet again. If the scheduling controller 8 determines that no packet exists within the queue A 14, it notifies the effect that the process of the packet within the queue A 14 has been finished to the path setting manager 11 (step B9).

The path setting manager 11 having received the notification saying that the transmission process of the packet within the queue A 14 has been finished determines whether a switchover of the all failed paths to the auxiliary path has been finished (step B10). In a case where the path setting manager 11 has received the packet relevant to the publication of the all failed paths, in which its own network device becomes a relaying node, from the network device that becomes a start-point node, it determines that a switchover of the all failed paths to the auxiliary path has been finished. And, if the path setting manager 11 determines that a switchover of the all failed paths to the auxiliary path has not been finished yet, it notifies the effect that a switchover of the all failed paths to the auxiliary path has not been finished yet to the scheduling controller 8 (step B11). The scheduling controller 8 having received the notification saying that a switchover to the auxiliary path has not been finished yet confirms existence of the packet within the queue A 14 again, and performs a transmission process again if it confirms that the packet exists.

On the other hand, the path setting manager 11 determines that a switchover of the all failed paths to the auxiliary path has been finished, it notifies the effect that a switchover of the all paths has been finished to the scheduling controller 8 (step B12). The scheduling controller 8 having received the notification saying that a switchover to the auxiliary path has been finished notifies the failure information notified from the failure information notifier 9 to the routing protocol section 6 (step B13). Additionally, the failure information was notified to the routing protocol section 6 from the scheduling controller 8; however it is also possible to employ the method in which the failure information is notified from the path setting manager 11 or the failure information notifier 9, the method in which the path setting manager 11 notifies the effect that a switchover of the all paths has been finished to the signaling protocol section 7 as well and the signaling protocol section 7 notifies the failure information notified from the failure information notifier 9 to the routing protocol section 6, or the like.

The routing protocol section 6 having received the failure information from the failure information notifier 9 transmits the packet relevant to the link state information for the purpose of updating the link state (step B14). The packets relevant to the link state information transmitted from the routing protocol section 6 are filed into the queue A 14, and are processed by the scheduling controller 8 (step B15). Upon finishing the transmission process of one packet within the queue A 14, the scheduling controller 8 determines existence of the packet within the queue A 14 (step B16), and if it determines that the packet exits, it performs a transmission process of the packet again, and if it determines that no packet exits, the failure recovery operations by the routing protocol section 6 and the signaling protocol section 7 are finished.

Performing such an operation makes it possible to start the publication by the routing protocol with it as a turning point that a switchover of the current path to the auxiliary path has been finished, thereby to avoid occurrence of a competition between the signaling packet and the routing packet and a congestion state, and to reduce the pre-planned failure recovery time in the network device (equivalent to the node device N4 of the case of FIG. 3) having detected the failure of the current path in which its own network device becomes a relaying node. Further, the congestion state of the routing packet and the signaling packet is avoided, thereby making it possible to lower a probability that the signaling packet is canceled, and to enhance a reliability of the failure recovery.

Next, an effect of this embodiment will be explained. The network device 4 relevant to this embodiment notifies the failure information to the signaling protocol section 7 in the first place, and notifies the failure information to the routing protocol section 6 at the time point that a switchover of the all failed path to the auxiliary path has been finished, thereby allowing the timing of the publication operation relevant to the failed path by the routing protocol section 6 and the timing of the failure recovery operation by the signaling protocol section 7 to deviate from each other, which eliminates a competition between the packet that is transmitted from the routing protocol section 6 and the packet that is transmitted from the signaling protocol section 7 in the communication path A 18, and enables the pre-planned failure recovery time to reduced. In addition hereto, the possibility that the signaling packet is cancelled is eliminated, which allows a reliability of the failure recovery to be enhanced.

In this embodiment, shifting the timing at which the failure information is notified allows the timing of the publication operation relevant to the failed path by the routing protocol section 6 and the timing of the failure recovery operation by the signaling protocol section 7 to deviate from each other; however employing such a step, in which the failure information is notified to the routing protocol section 6 and the signaling protocol section 7 at an identical timing, and the routing protocol section 6 does not start the failure publication operation immediately even though it is notified of the failure information, but starts the failure publication operation, for example, at the time point of having received the notification saying that a switchover of the all failed paths to the auxiliary path has been finished from the scheduling controller 9, also allows the similar effect to be obtained.

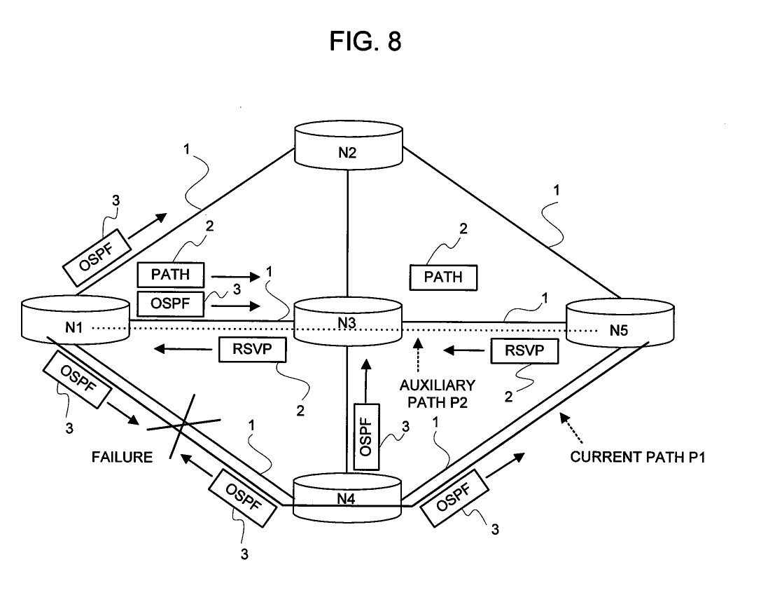

Next, an embodiment of the second failure recovery method of the present invention will be explained by making a reference to FIG. 8.

In FIG. 8, each of N1 to N5 signifies a node device constituting the GMPLS network, and 1 is a link connecting respective node devices N1 to N5. Any communicable line such as an optical fiber and an Ethernet (Registered Trademark) cable can be employed for the link 1.

In the GMPLS network shown in FIG. 8, an N1-N4-N5 path is determined as a current path P1. Further, the failure recovery type of this current path P1 is a type of 1:1 of the pre-planned recovery/path failure recovery technique, and an N1-N3-N5 path is determined as an auxiliary path that is used when the failure occurs in the current path P1, instead of its current path 1. Herein, in FIG. 8, it is the node device N1, being a start-point node of the path, that stores the fact that the auxiliary path for the current path P1 is P2. Additionally, only one current path that is P1 is determined in the GMPLS network shown in FIG. 8; however a plurality of the current paths, i.e. two or more may be determined. In this case, the Shared type of the pre-planned recovery/path failure recovery technique may be used, thereby allowing the two current paths to share the identical auxiliary path.

A signaling packet 2 shown in FIG. 8, which is a packet for switching the path at the time of occurrence of the failure, is transferred from the start-point node device N1 to the end-point node device N5 of the auxiliary path. Further, a routing packet 3 shown in FIG. 8 is a packet that is published to the neighboring node for the purpose of updating a link state due to a change in the link state caused by the failure at the time of occurrence of the failure, and yet a packet by a link-state type routing protocol, i.e. an OSPF protocol, or a packet by the routing protocol obtained by extending it for the GMPLS.

In the second failure recovery method, different communication paths are used to send out a routing packet 3 and a signaling packet 2, respectively. For example, physically different communication paths are used, different wavelengths over the physically identical communication path are assigned, or the like. In this embodiment, besides a first control channel packaged with out-of-band signaling that is generated over the communication path, a second control channel packaged with in-band signaling that is generated over the communication path is provided between the neighboring node devices, the packet by the signaling protocol and the packet by the routing protocol are exchanged between the node devices through the first control channel, respectively, in a case where the network normally operates, and one part of the packets by these two protocols is exchanged between the node devices through the second control channel in a case where the failure of the current path P1 occurs. For example, the second control channel is used for the Hello packet by the routing protocol and the packet by the signaling protocol, and the first control channel is used for the packet other than the Hello packet by the routing protocol.

Next, an operation of this embodiment in the case that the failure has occurred in any of the links of the current path P1 will be explained in details. Herein, the case that the failure has occurred in the link 1 connecting the node device N1 and the node device N4 is envisaged.

In the GMPLS network shown in FIG. 8, when a failure occurs in some link, the node devices at the ends of its link detect its failure. In this-time case, it is assumed that the failure has occurred in the link between the node device N1 and the node device N4, so the node device N1 and the node device N4 detect the failure.

The node device N1 and the node device N4 having detected the failure start the failure recovery, respectively. In this case, the node device N1 is a start-point node of the current path P1, and the node device N4 is not a start-point node of the current path P1, so they operate differently from each other. Hereinafter, the operations of the node device N1 and the node device N4 are explained, respectively.

At first, the failure recovery operation of the node device N1, being a start-point node of the current path P1, will be explained. Upon detecting the failure of the link between the node device N1 and the node device N4, the node device N1 uses the second control channel to transmit the signaling packet 2 by the signaling protocol, which is called the Path message, through the node device N3 to the node device N5, being an end-point node of the auxiliary path P2, for the purpose of switching the current path P1 using its link to the auxiliary path P2. Further, the node device N1 uses the first control channel to transmit the routing packet 3 for updating a change in the link state to the other node device because the failure has occurred in the link between the node device N1 and the node device N4.

The Path message by the signaling packet 2 requests the node over the failure recovery path of the auxiliary path P2 to set a label that is affixed link by link. The Path message is sent out to the node device N5 through the node device N3, being a relaying device. The node device N3 having received the Path message sets the switch in order to use the auxiliary path P2. Thereafter, the node device N3 sends out the Path message to the node device N5. The node device N5 having received the Path message determines that the received message is a packet addressed to its own node, and transmits to the node device N3 the signaling packet 2 that is called a Resv message through the path opposite to that of the Path message after setting the switch. After the node device N3 having received the Resv message changes label information within the Resv message, it sends out the Resv message to the node device N1. The node device N1 having received the Resv message, thereafter, transmits the packet, which was transmitted so far to the current path P1, to the auxiliary path P2 because the auxiliary path P2 has been determined. This means that a switchover of the failed current path P1 to the auxiliary path P2 has been completed. In FIG. 8, there exists no failed path, which has the node device N1 assumed to be a start-point node, other than the one current path P1; however if there exist a plurality of the failed paths having the node device N1 assumed to be a start-point node, the node device N1 switches the all failed paths to the auxiliary paths in a similar method to that of the case of having switched the failed current path P1 to the auxiliary path P2.

Further, the routing protocol in the node device N1 uses the first control channel to transmit the routing packet 3 to the node device N2, the node device N3, and the node device N4 for the purpose of updating a change in the state of the failed link. The node device N2 having received the routing packet 3 uses the first control channel likewise to transmit the routing packet 3 to the node device N3 and the node device N5. Thereafter, similarly hereto, the routing packet 3 for updating a change in the state of the failed link is sequentially transferred. Each node device having received the routing packet 3 performs an operation specified by the routing protocol, for example, an update of a topology database. When the topology databases of all node devices of the network are updated, the failure recovery operation initiated after occurrence of the failure is finished.

Next, the failure recovery operation of the node device N4, being a relaying node of the current path P1, will be explained. Upon detecting the failure of the link 1 between the node device N4 and the node device N1, the node device N4 determines that the failure has occurred in the current path P1 using its link 1. However, the start-point node of the current path P1 is not its own node device N4, and there exists no path other than the failed path having its own node device N4 assumed to be a start-point node, whereby the node device N4 does not execute such a failure recovery operation by the signaling protocol that the foregoing node device N1 executed. On the other hand, the node device N4, which has detected the failure of the link between the node device N4 and the node device N1, uses the first control channel to transmit the routing packet for updating a change in the link state to other node device according to the routing protocol.

Next, an effect of this embodiment will be explained.

In this embodiment, at the time of occurrence of the failure of the current path P1, the packets by two protocols of the routing protocol and the signaling protocol are distributed to the first and the second control channels, and exchanged between the node devices, respectively, thereby enabling occurrence of the congestion state due to a competition between the signaling packet and the routing packet within the control channel to be avoided, and the pre-planned failure recovery time to be reduced. Further, the congestion state of the signaling packet and the routing packet is avoided, thereby making it possible to lower a probability that the signaling packet is cancelled, and to enhance a reliability of the failure recovery.

Next, an embodiment of the network control device that is used in the second failure recovery method of the present invention will be explained in details by making a reference to the accompanied drawings.

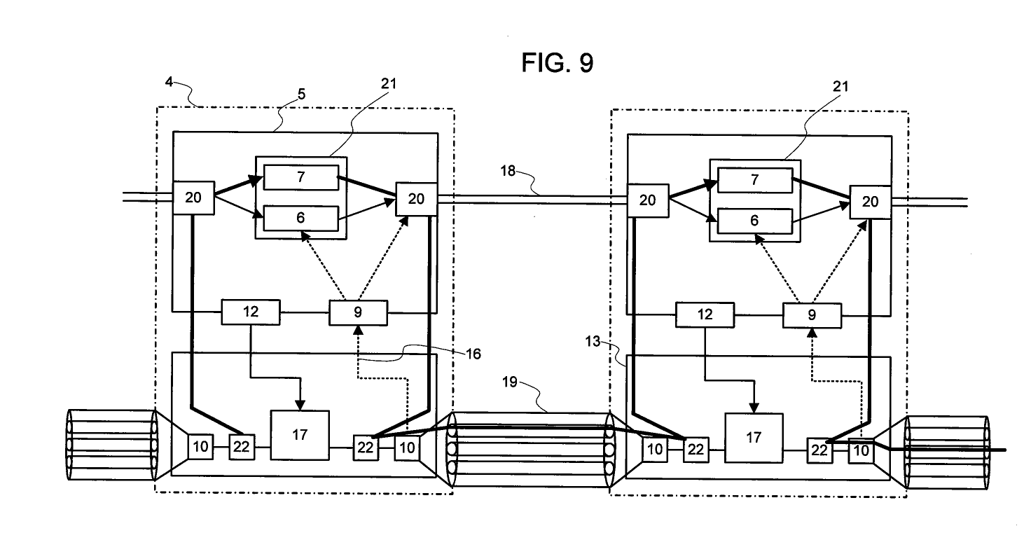

Upon making a reference to FIG. 9, a network device 4 relevant to this embodiment is configured of a GMPLS controller 5 constituting the control network, and a switch section 13. The network device 4 shown in this FIG. 9 is used as the node device (the node devices N1 to N5 of FIG. 8) in the GMPLS network in which the steps of the second failure recovery method of the present invention explained by making a reference to FIG. 8 are performed.

The GMPLS controller 5 includes a group of control modules 21 having a routing protocol section 6 and a signaling protocol section 7, a transmitter/receiver 20, a failure information notifier 9, a switch controller 12, and a communication path A 18 with the GMPLS controller 5 of the other network device 4. Further, the switch section 13 includes a switch 17 for transferring the data packet, a monitor section 10 for detecting the link failure etc., an in-band control channel separator 22, and a communication path B 19 with the switch section 13 of the other network device 4. Roughly speaking, theses components have the following function.

The switch 17 performs a process for transferring the data packet transmitted from the other network device 4 to the yet other network device 4.

The communication path B 19, which is a communication path for transferring the data packet for which the data transfer process has been performed in the switch 17 to a transmission destination, is also utilized as a communication path for transmitting/receiving the control packet in the case of this embodiment.

The monitor section 10 monitors whether the failure has occurred in the link over the communication path B 19 or the other network device 4 (node device) connected via its link, and upon detecting the failure of the link or the other node device, it sends out failure information including information etc. of the location in which the failure has occurred to the failure information notifier 9.

The switch controller 12 controls the switch 17 within the switch section 13.

The failure information notifier 9 receives failure information that is notified from the monitor section 10 within the switch section 13, and notifies its failure information to the routing protocol section 6, the signaling protocol section 7 and the transmitter/receiver 20.

In a case where the network normally operates, the routing protocol section 6 uses the transmitter/receiver 20 to make a topology exchange with the neighboring node, and carries out a preparation of the routing table, a publication of the TE link, an exchange of the Hello packet for maintaining a relation with the neighboring node, or the like. Further, when the routing protocol section 6 is notified of the failure information from the failure information notifier 9, i.e. at the time of the failure, the former uses the transmitter/receiver 20 to carry out an update of the link state information, an exchange of the Hello packet for maintaining a relation with the neighboring node or the like, similarly to the case that the network normally operates.

In a case where the network normally operates, the signaling protocol section 7 uses the transmitter/receiver 20 to carry out a setting of the LSP, a deletion of the LSP, a management of the setting state of the LSP, or the like. Further, when the signaling protocol section 7 is notified of the failure information from the failure information notifier 9, i.e. at the time of the failure, the former uses the transmitter/receiver 20 to switch the failed path to the auxiliary path if the notified failure is a failure of the current path having its own network device 4 assumed to be a start-point node.

The transmitter/receiver 20 transmits/receives the packet by the routing protocol section 6 and the signaling protocol section 7 between the neighboring network devices. In a case the network normally operates, the transmitter/receiver 20 uses the communication path A 18 to transmit/receive the packets by the routing protocol section 6 and the signaling protocol section 7. On the other hand, when the transmitter/receiver 20 is notified of the failure information from the failure information notifier 9, i.e. at the time of occurrence of the failure, the former uses the communication path B 19 to transmit/receive the Hello packet by the routing protocol section 6 and the packet by the signaling protocol section 7, and uses the communication path A 18 to transmit/receive the packet other than the Hello packet by the routing protocol section 6. In this embodiment, the transmitter/receiver 20 uses an overhead of a SONET/SDH (Synchronous Optical Network/Synchronous Digital Hierarchy) to transmit/receive the packet that is transmitted by the signaling protocol section 7 and the Hello packet for confirming existence with the neighborhood that is transmitted from the routing protocol section 6.

The in-band control channel separator 22 uses the communication path B 19 to transmit the signaling packet and the Hello packet, which was delivered from the transmitter/receiver 20 of its own network device 4, to the neighboring network device 4, further, separates the packets received through the communication path B 19 from the neighboring network device 4 into the signaling packet and the Hello packet, and the packet other than theses packets, sends out the former two packets to the transmitter/receiver 20 of its own network device 4, and sends out the latter packet to the switch 17 of its own network device 4.

Next, an operation of the network device 4 relevant to this embodiment will be explained in details. In the first place, the operation of the case that the network normally operates will be explained by making a reference to a block diagram of FIG. 9.

In a case where that the network normally operates, the routing protocol section 6 makes a topology exchange with the neighboring node, and transmits/receives the packets for the purpose of preparing the routing table, publishing the TE link, exchanging the Hello packet for maintaining a relation with the neighboring node, or the like. The packet that is transmitted from the routing protocol section 6 is transmitted/received between the network devices 4 by the transmitter/receiver 20 by using communication path A 18. Further, the signaling protocol section 7 transmits/receives the packets for the purpose of setting the LSP, deleting the LSP, managing the setting state of the LSP, and the like. Likewise, the packet also that is transmitted from the signaling protocol section 7 is transmitted/received between the network devices 4 by the transmitter/receiver 20 by using the communication path A 18.

On the other hand, the switch 17 of the switch section 13 transfers the data packet under control of the switch controller 12. Transmission/reception of the data packet between the network devices 4 is made through the communication path B 19.

The operation of the case that the network normally operates is one described above.

Next, an operation of the network device 4 (equivalent to the node device N1 in the case of FIG. 8) having detected the failure of the current path in which its own network device becomes a start-point node will be explained by making a reference to a block diagram of FIG. 9.

When the failure occurs in the link over the communication path B 19 or the other network device 4 (node device) connected via the communication path B 19, the monitor section 10 of the network device 4 detects the failure, and failure information is notified to the failure information notifier 9 from the monitor section 10. The failure information notifier 9 having received the failure information notifies the failure information to the group of control modules 21 and the transmitter/receiver 20. The group of control modules 21 having received the failure information starts the failure recovery. The signaling protocol section 7 that is included in the group of control modules 21 transmits the packet for switching the failed path, and the routing protocol section 6 transmits the packet for updating a change in the state of the failed link, respectively. The transmitted packet is filed into a queue or a buffer within the transmitter/receiver 20 that is not shown in the figure. The transmitter/receiver 20, which has already received the failure information, potions out the packets to the routing packet, and the signaling packet and the Hello packet, being one part of the routing packet. The communication path A 18 is used to send out the routing packet, and the communication path B 19 is used to send out the signaling packet and the Hello packet. A DCC (Data Communications Channel) within the overhead of the SONET/SDH is used within the communication path B 19.

When the routing packet sent out by using the communication path A 18 arrives at the neighboring node, it is delivered to the routing protocol section 6 by the transmitter/receiver 20. When the packet sent out by using the communication path B 19 arrives at the neighboring node, it is sent out to the GMPLS controller 5 so long as it is the signaling packet or the Hello packet, and it is sent out to the switch 17 so long as it is the packet other than these packets in the in-band control channel separator 22.

The operation of the network device 4 (equivalent to the node device N4 of FIG. 8) having detected the failure of the current path in which its own network device becomes a relaying node differs from that of the network device 4 (equivalent to the node device N1 of FIG. 8) having detected the failure of the current path in which its own network device becomes a start-point node only in a point that the operation of switching the failed path to the auxiliary path by the signaling protocol section 7 is not executed, and the operation other than it is almost identical.

Next, an effect of this embodiment will be explained. The network device 4 relevant to this embodiment uses the communication path A 18 packaged with out-of-band signaling for the packet that is transmitted by the routing protocol section 6, and uses one part of the communication path B 19 packaged with in-band signaling for the packet that is transmitted by the signaling protocol section 7 at the time of failure of the current path, thereby allowing a competition within the control channel to be eliminated. This enables the packet for switching the path at the time of occurrence of the failure to be processed quickly, which can reduce the failure recovery time. In addition hereto, this enables the packet that is transmitted by the signaling protocol section 7 to be processed quickly, which eliminates the packet cancellation. This enables a reliability of the failure recovery to be enhanced. In addition hereto, the communication path A 18 is used only for the packet that is transmitted by the routing protocol section 6. This enables the control channel bandwidth to be designed at a small size by taking into consideration only the packet that is transmitted by the routing protocol section 6.

Above, the embodiments of the present invention were explained; however the present invention is not limited to the above-mentioned embodiments, and the other various additional modifications are possible. For example, in the GMPLS, there exists a link management protocol for the group of the control modules 21 in addition to the routing protocol and the signaling protocol, and a scheduler algorithm also can be actuated between the link management protocol and the signaling protocol. The link management protocol starts an operation of exchanging the control packet (Channel Status message and Channel Status Ack message) for specifying a failure position with the neighboring node at the time that the failure has occurred. Replacing the step of sending out this Channel Status message with the step of sending out the link information by the routing protocol according to the technique of the present invention makes it possible to realize a reduction in the time of the failure recovery. Further, not only the function that the network device of the present invention has can be realized in a hardware manner as a matter of course, but also it can be realized with a computer and a program. The program, which is recorded in computer-readable record mediums such as a magnetic disc and a semiconductor memory, is provided, and is loaded onto the computer at the time of setting up the computer or the like, controls an operation of its computer, thereby to cause its computer to function as means such as the routing protocol section 6, the signaling protocol section 7, the scheduling controller 8, the path setting manager 11, the failure information notifier 9, and the switch controller of the network device 4 in each of the foregoing embodiments.

1. A failure recovery method in a network that is configured of a plurality of network devices comprising a group of control modules having a routing protocol section for exchanging link information and a signaling protocol section for determining a path, characterized in that when a failure occurs in a link constituting a current path, a first network device for performing a process of switching said one or more failed current paths to auxiliary paths previously computed start to transmit a routing packet relevant to a publication of the failed link by said routing protocol section after the time point that said signaling protocol section has finished transmission of a signaling message for switching all or one part of said failed one or more current paths to the auxiliary paths.

2. The failure recovery method according to claim 1, characterized in that said first network device starts a publication of the failed link by said routing protocol section with it as a turning point that a switchover to the auxiliary paths has been finished by said signaling protocol section.

3. The failure recovery method according to claim 2, characterized in that said first network device determines that a switchover to the auxiliary paths has been finished when it has confirmed one round trip of the signaling message for switching said failed current path by the said signaling protocol section along a failure recovery path.

4. The failure recovery method according to claim 2, characterized in that a second network device other than said first network device for switching said failed current path to the auxiliary path previously computed starts to transmit a routing packet relevant to the publication of the failed link by said routing protocol section with it as a turning point that a switchover of all or one part of said failed one or more current paths to the auxiliary paths has been finished, said second network device being a network device having detected the failure that has occurred in the link constituting the current path.

5. The failure recovery method according to claim 4, characterized in that when said second network device has received the routing packet relevant to the publication of the failed link from said first network device, it determines that a switchover of all or one part of said failed one or more current paths to the auxiliary paths has been finished.

6. A failure recovery method in a network that is configured of a plurality of network devices comprising a group of control modules having a routing protocol section for exchanging link information and a signaling protocol section for determining a path, characterized in that a second control channel packaged with in-band signaling channel over a communication path is provided between the neighboring network devices, besides a first control channel packaged with out-of-band signaling over a communication path, and when a failure occurs in a link constituting a current path determined by said signaling protocol section, each of a packet for switching said one or more failed current paths to auxiliary paths by said signaling protocol section, and a routing packet relevant to a publication of the failed link by said routing protocol section is transmitted/received between the network devices through a different control channel, said different control channel being one of said first control channel and said second control channel.

7. A network device including a monitor section for detecting a failure, a failure information notifier for notifying the failure detected by the monitor section, a scheduling controller for carrying out a control of scheduling such as a change of a scheduling algorithm, and a group of control modules each of which become an object of scheduling, characterized in changing the scheduling algorithm that is applied for said group of control modules with the failure as a turning point.

8. A network device comprising a group of control modules having a routing protocol section for exchanging link information and a signaling protocol section for determining a path, characterized in that said network device, which comprises a path setting manager for, when a failure occurs in a link constituting a current path, detecting that a switchover of all or one part of said one or more failed current paths to auxiliary paths by the signaling protocol has been finished, does not transmit a routing packet relevant to a publication of the failed link by said routing protocol section until the path setting manager carries out said detection.

9. A network device comprising a group of control modules having a routing protocol section for exchanging link information and a signaling protocol section for determining a path, characterized in comprising:
a failure information notifier for simultaneously notifying a failure of a current path to said signaling protocol section and said routing protocol section;
a first queue into which a signaling packet of said signaling protocol section and a Hello packet of said routing protocol section are filed at the time of the failure of the current path;
a second queue into which packets other than the Hello packet of said routing protocol section are filed at the time of the failure of the current path;
a path setting manager for, at the time of the failure of the current path, monitoring whether a switchover of all failed paths to auxiliary paths has been finished; and
a scheduling controller for, at the time of the failure of the current path, taking a transmission control of the packets filed into said first queue until a switchover of all failed paths to auxiliary paths is finished, and afterward, taking a transmission control of the packets filed into said second queue.

10. A network device comprising a group of control modules having a routing protocol section for exchanging link information and a signaling protocol section for determining a path, characterized in comprising:
a failure information notifier for notifying a failure of a current path to said signaling protocol section;
a queue into which a signaling packet of said signaling protocol section and a routing packet of said routing protocol section are filed;
a path setting manager for, at the time of the failure of the current path, monitoring whether a switchover of all failed paths to auxiliary paths has been finished, and if a switchover of all failed paths to auxiliary paths has been finished, allowing said failure of said current path notified to said signaling protocol section to be notified to said routing protocol section as well; and
a scheduling controller for taking a transmission control of the packets filed into said queue.

11. A network device comprising a group of control modules having a routing protocol section for exchanging link information and a signaling protocol section for determining a path, characterized in comprising:
a failure information notifier for notifying a failure of a current path to said signaling protocol section and said routing protocol section;
a transmitter/receiver for, at the time of the failure of the current path, transmitting/receiving a Hello packet by said routing protocol section and a packet by said signaling protocol section to/from the other network device through a first control channel packaged with in-band signaling, and transmitting/receiving the packets other than the Hello packet by said routing protocol section to/from the other network device through a second control channel packaged with out-of-band signaling; and
a separator for transmitting the packet delivered from said transmitter/receiver to the neighboring network device by using said first control channel, and sending out the packet received through said first control channel from the neighboring network device to said transmitter/receiver.

12. A program causing a computer constituting a network device, which comprises a group of control modules having a routing protocol section for exchanging link information and a signaling protocol section for determining a path and includes a first queue into which a signaling packet of said signaling protocol section and a Hello packet of said routing protocol section are filed at the time of a failure of a current path and a second queue into which the packets other than the Hello packet of said routing protocol section are filed at the time of the failure of the current path, to function as:
failure information notification means for simultaneously notifying the failure of the current path to said signaling protocol section and said routing protocol section;
path setting management means for, at the time of the failure of the current path, monitoring whether a switchover of all failed paths to auxiliary paths has been finished; and
scheduling control means for, at the time of the failure of the current path, taking a transmission control of the packets filed into said first queue until a switchover of all failed paths to auxiliary paths is finished, and afterward, taking a transmission control of the packets filed into said second queue.

13. A program causing a computer constituting a network device, which comprises a group of control modules having a routing protocol section for exchanging link information and a signaling protocol section for determining a path and includes a queue into which a signaling packet of said signaling protocol section and a routing packet of said routing protocol section are filed, to function as:
failure information notification means for notifying a failure of a current path to said signaling protocol section;
path setting management means for, at the time of the failure of the current path, monitoring whether a switchover of all failed paths to auxiliary paths has been finished, and if a switchover of all failed paths to auxiliary paths has been finished, allowing said failure of said current path notified to said signaling protocol section to be notified to said routing protocol section as well; and
scheduling control means for taking a transmission control of the packets filed into said queue.

14. The failure recovery method according to claim 3, characterized in that a second network device other than said first network device for switching said failed current path to the auxiliary path previously computed starts to transmit a routing packet relevant to the publication of the failed link by said routing protocol section with it as a turning point that a switchover of all or one part of said failed one or more current paths to the auxiliary paths has been finished, said second network device being a network device having detected the failure that has occurred in the link constituting the current path.
